(19) United States
(12) Patent Application Publication
(10) Pub. No.: US 2003/0117072 A1
(43) Pub. Date: Jun. 26, 2003

(54) Method and apparatus for forming barrier ribs for use in flat panel displays, and back plates manufactured by this method

(75) Inventor: Manabu Yabe, Kyoto (JP)

Correspondence Address: McDermott, Will & Emery, 600 13th Street, N.W., Washington, DC, 20005-3096, US

(73) Assignee: DAINIPPON SCREEN MFG. CO., LTD.

(21) Appl. No.: 10/323,793

(22) Filed: Dec. 20, 2002

(30) Foreign Application Priority Data
Dec. 21, 2001 (JP) JP2001-389471

(51) Int. Cl. H01J 17/02

(52) U.S. Cl. 313/609

(57) ABSTRACT

A method of forming barrier ribs on a back plate for use in a flat panel display. The method includes a step of delivering a rib material from a nozzle and leveling surfaces of the barrier ribs while moving the nozzle and back plate relative to each other.

### BACKGROUND OF THE INVENTION

(1) Field of the Invention

This invention relates to a method and apparatus for forming barrier ribs for use in flat panel displays such as plasma display panels (referred to hereinafter as PDP) built into computer display terminals, wall-mounted television receivers or the like, and to back plates manufactured by this method. More particularly, the invention relates to a technique for forming barrier ribs by delivering a rib material directly to a back plate.

(2) Description of the Related Art

In a conventional barrier rib forming method of the type noted above, the rib material is delivered from a nozzle to a back plate while the nozzle and back plate are moved relative to each other. In this way, barrier ribs are formed directly on the back plate.

The conventional method with the above feature has the following drawback.

The barrier ribs formed by the conventional method are unsatisfactory in that the surfaces (upper surfaces and side surfaces) thereof are uneven and marked by undulation. In other words, the barrier ribs have their height, width and shape varying in small amplitudes with time. When a PDP is assembled by using a back plate having the barrier ribs with such low surface planarity, the PDP is bound to have low assembling accuracy. Thus, in conventional practice, despite an increase in the number of manufacturing steps, a grinding step is added for improving the surface planarity of the barrier ribs to secure high assembling accuracy.

### SUMMARY OF THE INVENTION

This invention has been made having regard to the state of the art noted above, and its object is to provide a method and apparatus for forming barrier ribs for use in flat panel displays, and a back plate manufactured by this method, in which the surfaces of a rib material are physically leveled to smooth the surfaces and secure improved surface planarity of the barrier ribs.

To solve the problem noted above, Inventor has made intensive research and found the following cause.

The undulating unevenness of the barrier rib surfaces noted above is caused by an imbalance (ununiform distribution) in the rib material, variations among lots of the rib material, variations in the relative moving velocity between the nozzle and back plate, or changes with time of a delivery pressure in time of delivery. The planarity of barrier ribs may be maintained by suppressing these time-dependent variations or changes, but this is extremely difficult. The problem may be solved simply by smoothing out the unevenness occurring with the barrier ribs.

Based on the above findings, this invention provides a method of forming barrier ribs on a back plate for use in a flat panel display, the method comprising a step of delivering a rib material from a nozzle and leveling surfaces of the barrier ribs while moving the nozzle and the back plate relative to each other.

The surfaces of the barrier ribs delivered from the nozzle and formed on the back plate are leveled to smooth out the unevenness of the surfaces of the barrier ribs caused by an imbalance in the rib material, variations among lots of the rib material, variations in the relative moving velocity between the nozzle and back plate, or changes with time of a delivery pressure in time of delivery. Thus, the surfaces of the barrier ribs have improved planarity.

In this invention, the surfaces of the barrier ribs, preferably, are upper surfaces of the barrier ribs.

By leveling the upper surfaces of the surfaces including the upper and side surfaces of the barrier ribs, a faceplate joined with the upper surfaces with high accuracy when assembling a PDP. Further, the number of manufacturing steps may be reduced by omitting a grinding step for leveling the upper surfaces of the barrier ribs.

Preferably, the rib material delivered from the nozzle is irradiated with light or heat.

The rib material delivered from the nozzle is cured by the irradiation of light or heat, thereby suppressing deformation the leveled barrier ribs.

In another aspect of the invention, a method of forming barrier ribs on a back plate for use in a flat panel display is provided, the method comprising a step of delivering a rib material from a nozzle and shaping a sectional profile of the barrier ribs while moving the nozzle and the back plate relative to each other.

The sectional profile of the rib material delivered from the nozzle to a predetermined profile, thereby to smooth out the unevenness of the surfaces of the barrier ribs caused by an imbalance in the rib material, variations among lots of the rib material, variations in the relative moving velocity between the nozzle and back plate, or changes with time of a delivery pressure in time of delivery. Thus, the surfaces of the barrier ribs have improved planarity.

In a further aspect of the invention, an apparatus for forming barrier ribs on a back plate for use in a flat panel display is provided, the apparatus comprising a nozzle for delivering a rib material, a support table for supporting the back plate, a moving device for moving the nozzle and the support table relative to each other, and a leveling device for leveling surfaces of the barrier ribs on the back plate, wherein the rib material is delivered from the nozzle and the barrier ribs are leveled by the leveling device while the nozzle and the back plate are moved relative to each other by the moving device.

The above apparatus delivers the rib material from the nozzle while the moving device causes a relative movement. At this time, the leveling device levels the surfaces of the barrier ribs formed on the back plate to render the surfaces smooth. Thus, the surfaces of the barrier ribs have improved planarity.

In a still further aspect of the invention, an apparatus for forming barrier ribs on a back plate for use in a flat panel display is provided, the apparatus comprising a nozzle for delivering a rib material, a support table for supporting the back plate, a moving device for moving the nozzle and the support table relative to each other, and a shaping device for shaping a sectional profile of the barrier ribs on the back plate, wherein the rib material is delivered from the nozzle and the barrier ribs are shaped by the shaping device while the nozzle and the back plate are moved relative to each other by the moving device.

The above apparatus delivers the rib material from the nozzle while the moving device causes a relative movement. At this time, the shaping device shapes the sectional profile of the barrier ribs and levels the surfaces of the barrier ribs. Consequently, the surfaces of the barrier ribs are smoothed to have improved planarity.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a side view schematically showing an outline of an apparatus for forming barrier ribs for use in flat panel displays according to this invention;

FIG. 2 is a view of a nozzle seen from below;

FIG. 3 is an enlarged view of a delivery unit;

FIG. 4 is an explanatory view of a process of leveling upper surfaces of barrier ribs with a leveling bar;

FIG. 5 is an explanatory view of a process of leveling upper surfaces of barrier ribs with a blade in a first modification;

FIG. 6 is a front view showing a second modification;

FIG. 7 is a view in vertical section of shaped barrier ribs in the second modification;

FIG. 8 is a front view showing a third modification;

FIG. 9 is a view in vertical section of shaped barrier ribs in the third modification;

FIG. 10 is a front view showing a fourth modification; and

FIG. 11 is a view in vertical section of a shaped barrier rib in the fourth modification.

### DESCRIPTION OF THE PREFERRED EMBODIMENTS

A preferred embodiment of this invention will be described hereinafter with reference to the drawings.

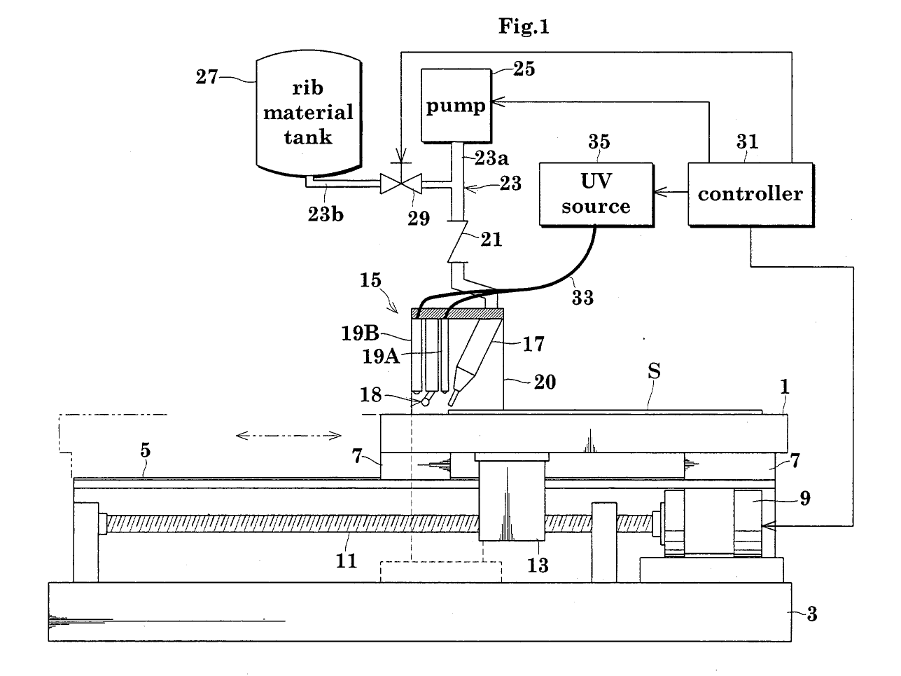

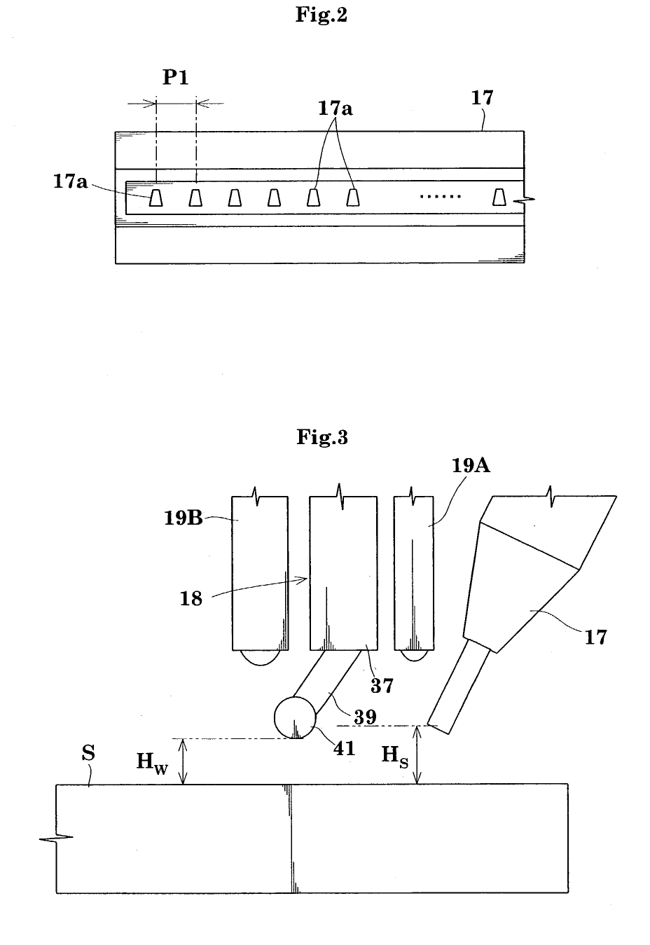

FIGS. 1 through 3 show one embodiment of this invention. FIG. 1 is a side view schematically showing an outline of an apparatus for forming barrier ribs for use in flat panel displays. FIG. 2 is a view of a nozzle seen from below. FIG. 3 is an enlarged view of a delivery unit.

A back plate S for a flat panel display such as a PDP is, for example, a glass substrate which is placed on a support table 1. A pair of guide rails 5 (only one being shown) are arranged on a base 3 disposed below the support table 1. Slide members 7 are slidably fitted on the guide rails 5. With these components, the support table 1 is movable right and left in FIG. 1.

A motor 9 is mounted on an upper surface of the base 3, with a rotary shaft extending horizontally. A screw shaft 11 is connected to the rotary shaft of motor 9, and a connecting piece 13 attached to the lower surface of support table 1 is meshed with the screw shaft 11. Thus, by operating the motor 9, the support table 1 is moved right and left. The motor 9 corresponds to the moving device of this invention.

A delivery unit 15 for delivering a rib forming material is erected adjacent a left-hand end of the support table 1 in an illustrated initial position and adjacent the center of the base 3. The delivery unit 15 includes a nozzle 17, a leveling mechanism 18 and two light emitters 19A and 19B, and is attached to a frame 20 mounted on the base 3 to straddle the support table 1. The two light emitters 19A and 19B correspond to the curing device of this invention. The light emitter 19A is disposed rearwardly of the nozzle 17 and forwardly of the leveling mechanism 18. The light emitter 19B is disposed to the left of the leveling mechanism 18. The nozzle 17 is tilted with a tip end thereof directed forwardly with respect to movement of the back plate S, so that the rib material may be maintained in a shape corresponding to the sectional profile of discharge openings of the nozzle 17.

In this apparatus, the rib material is delivered from the nozzle 17 as the support table 1 moves leftward from the illustrated initial position. The two light emitters 19A and 19B emit light to the rib material delivered to promote curing thereof. This apparatus employs a construction for effecting a curing process in two stages. Specifically, the light emitter 19A emits light to the rib material immediately after delivery from the nozzle 17 to cure the material. The light emitter 19B emits light to barrier ribs with upper surfaces thereof being leveled or having been leveled by the leveling mechanism 18, for further curing the barrier ribs. The light emitters 19A and 19B emit ultraviolet light, and the light emitter 19B is set for a higher light intensity than the light emitter 19A.

As shown in FIG. 2, the nozzle 17 defines a plurality of discharge openings 17a arranged in a row in a direction normal to the plane of FIG. 1. In this apparatus, each discharge opening 17a is shaped trapezoidal and has a height in the moving direction of the support table 1. The discharge openings 17a each have a short side of about 30 μm, and are arranged at a pitch P1 of about 150 μm, for example. The shape of discharge openings 17a is not limited to trapezoidal, but may be varied, e.g. rectangular or oval.

The nozzle 17 is connected to a supply pipe 23 with a check valve 21 mounted thereon. The supply pipe 23 has an upper pipe 23a connected to a pump 25, and a branch pipe 23b extending from the upper pipe 23a upstream of the check valve 21 to a rib material tank 27. The rib material tank 27 stores the rib material of the ultraviolet curable type with a binder containing a UV curable resin. The branch pipe 23b has a switch valve 29 mounted thereon. The above motor 9, pump 25 and switch valve 29 are controlled en bloc by a controller 31.

The rib material delivering mechanism having the above construction is operable as follows.

The pump 25 is first operated to take sucking action, with the switch valve 29 opened, to draw the rib material into the upper pipe 23a. At this time, the check valve 21 prevents a rib material remaining in the nozzle 17 from being drawn back. Next, the pump 25 is operated to take discharging action, with the switch valve 29 closed, to discharge the rib material from the upper pipe 23a out through the check valve 21, thereby supplying the rib material to the nozzle 17. By repeating a series of these operations, the rib material is delivered from the discharge openings 17a of the nozzle 17.

Each of the light emitters 19A and 19B noted hereinbefore has an optical fiber 33 connected thereto. The optical fiber 33 extends from an ultraviolet source 35. Ultraviolet light from the ultraviolet source 35 is transmitted through the optical fibers 33, and emitted from the light emitters 19A and 19B toward the support table 1.

As shown in FIG. 3, the delivery unit 15 includes the leveling mechanism 18 corresponding to the leveling device of this invention.

The leveling mechanism 18 has a base plate 37, a connecting tilt plate 39 and a leveling bar 41. These components all have depths in the direction along the plane of FIG. 3, and a width substantially corresponding to the width of the back plate S. The base plate 37 serves to attach the connecting tilt plate 39 to the frame 20 to depend from the latter. The connecting tilt plate 39 serves to connect the leveling bar 41 of circular section to the base plate 37, such that the leveling bar 41 is offset toward the light emitter 19B from a mounting shaft of the base plate 37. Preferably, the connecting tilt plate 39 is formed of a material transparent to the ultraviolet light emitted from the light emitter 19B.

The spacing between the lower end of leveling bar 41 and the back plate S is adjusted in advance to be less than a depositing height H_{S} of the rib material delivered from the nozzle 17 and to correspond substantially to an intended or target height H_{W} of the barrier ribs. Preferably, the leveling bar 41 is formed of fluoroplastic or the like, so that the rib material may not easily adhere thereto.

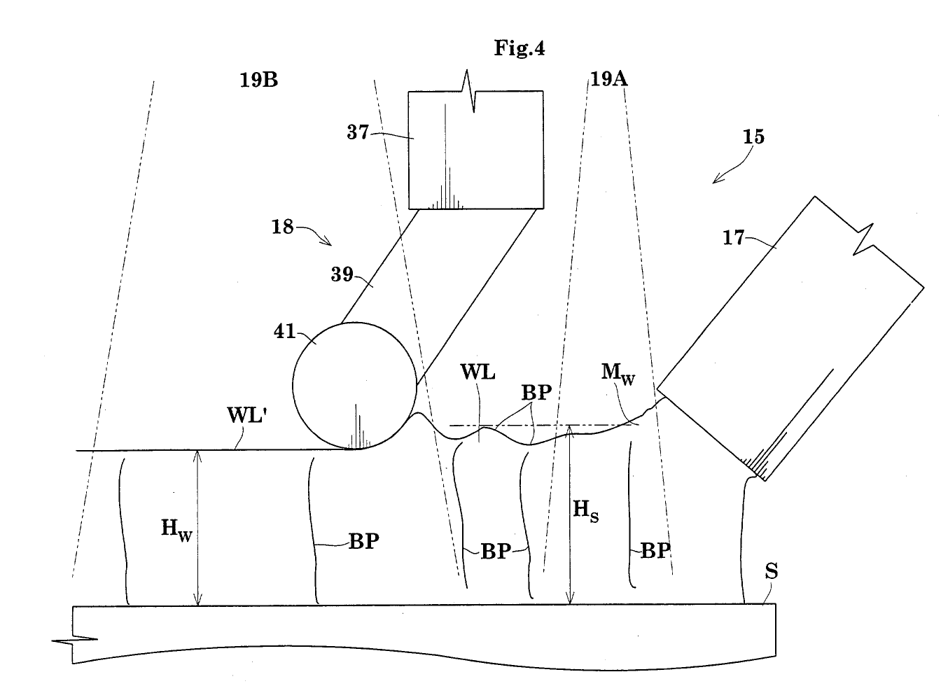

A rib forming operation by the above apparatus will be described next with reference to FIG. 4. FIG. 4 is an explanatory view of a process of leveling upper surfaces of barrier ribs with the leveling bar 41.

First, a back plate S is placed on the support table 1, and fixed thereto by suction, for example. The ultraviolet source 35 is turned on in advance to stabilize output of ultraviolet light and to emit the light from the light emitters 19A and 19B.

Next, while rotating the motor 9 at fixed speed, the controller 31 controls the pump 25 and switch valve 29 as described hereinbefore, to deliver the rib material from the nozzle 17. Then, the support table 1 is moved at fixed speed leftward from the initial position shown in FIG. 1. As a result, the rib material M_{W} delivered in a plurality of flows from the nozzle 17 deposits to form linear barrier ribs WL having the depositing height H_{S} on the upper surface of back plate S.

At this time, the rib material M_{W} delivered from the nozzle 17 has minute bulges and dimples BP formed on upper and side surfaces thereof owing to variations in delivery pressure or an imbalance of the rib material M_{W}. The rib material M_{W} is cured to a certain degree by the ultraviolet light from the light emitter 19A. Subsequently, the leveling bar 41 presses and straightens the minute bulges and dimples BP formed on the upper surfaces of the barrier ribs WL, and levels the barrier ribs WL to the height H_{W}.

The leveling bar 41 is formed of a material not easily allowing adhesion of the rib material M_{W}, and has an arcuate contour in the direction of movement, which minimize adhesion of the rib material M_{W} to the leveling bar 41. At this time, the ultraviolet light from the light emitter 19B further cures portions of the barrier ribs WL being leveled and portions having just been leveled. This results in barrier ribs WL′ with flat and smooth upper surfaces.

The provisional curing step taken immediately after delivery has the effect of holding the rib material M_{W} against drooping. Thus, the barrier ribs WL are formed at the pitch P1 of arrangement of the discharge openings 17a. The further curing of the portions being leveled and portions having just been leveled by the leveling bar 41 has the effect of steadily maintaining the shape of barrier ribs WL′ with improved planarity. After forming the barrier ribs WL′ with upper surfaces having improved planarity as described above, the product is baked at a temperature of 500 to 600° C. to complete the back plate S with the barrier ribs WL′ for a flat panel display.

While the above apparatus levels only the upper surfaces of the barrier ribs, the leveling mechanism 18 may include side leveling bars suspended as slightly less spaced from each other than the width of the rib material delivered, to level also the side surfaces of the barrier ribs.

Though the two light emitters 19A and 19B are arranged in the delivery unit 15, only one light emitter may be provided.

The apparatus in this embodiment delivers the rib material M_{W} from the nozzle 17, and levels the surfaces of barrier ribs WL formed on the back plate S. The apparatus thereby smoothes out the bulges and dimples BP formed on the upper surfaces of barrier ribs WL owing to an imbalance in the rib material M_{W}, variations among lots of the rib material M_{W}, variations in the relative moving velocity between the nozzle and back plate, or changes with time of a delivery pressure in time of delivery. Thus, the surfaces of the barrier ribs have improved planarity.

This invention is characterized by the leveling mechanism 18 for leveling the surfaces of the barrier ribs as noted above. The leveling mechanism 18 may be modified as described hereinafter.

<First Modification>

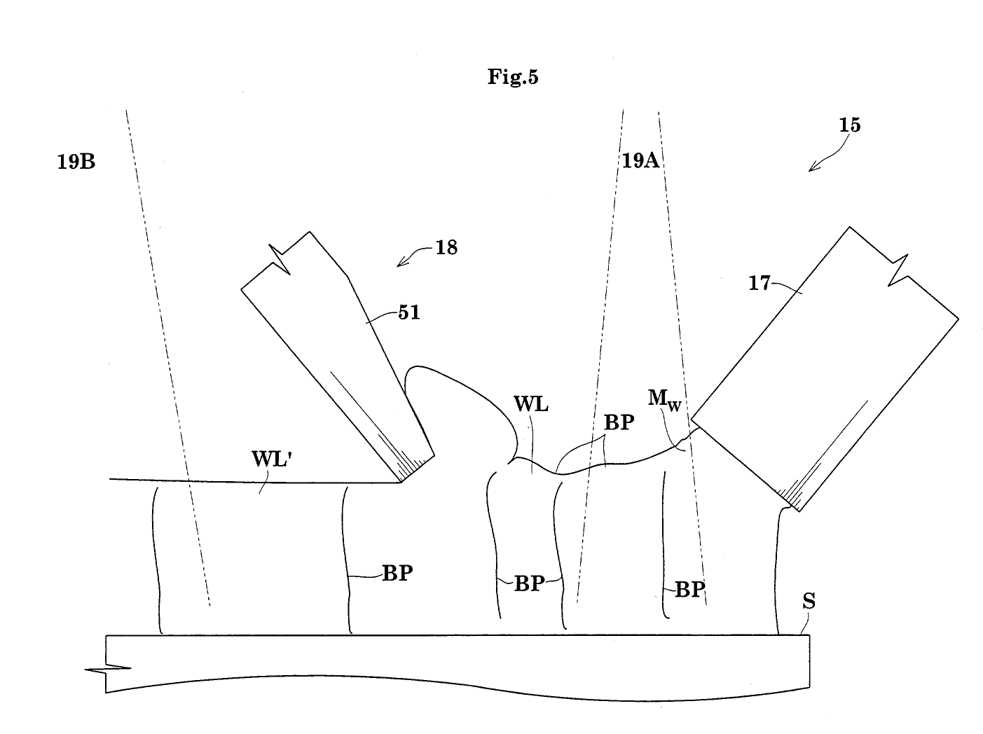

A modified leveling mechanism 18 will be described with reference to FIG. 5. FIG. 5 is an explanatory view of a process of leveling upper surfaces of barrier ribs with a blade.

In this modification, the above leveling bar 41 is replaced by a blade 51 shaped to have flat surfaces for contacting the barrier ribs. Preferably, as is the leveling bar 41, the blade 51 is formed of a material hardly allowing adhesion thereto of the rib material M_{W}. The blade 51 is attached to have its contact portion tilted toward oncoming rib material M_{W}. A leveling step is executed to level the upper surfaces of barrier ribs WL by scraping off the minute bulges and dimples BP. By employing the above posture, the rib material M_{W} remaining on an upper surface of blade 51 is prevented from adhering back to the leveled upper surfaces of barrier ribs WL′.

<Second Modification>

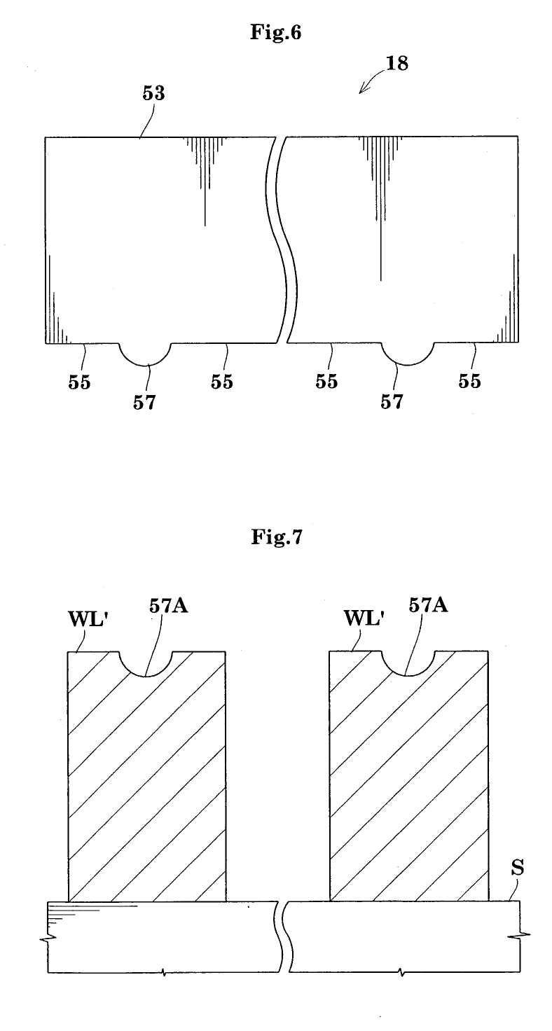

A second modification of the leveling mechanism 18 will be described with reference to FIGS. 6 and 7. FIG. 6 is a front view showing the second modification (seen from the right-hand side in FIG. 1). FIG. 7 is a view in vertical section of shaped barrier ribs in the second modification.

This modification is constructed for forming grooves in the upper surfaces of barrier ribs WL as well as leveling the upper surfaces.

The modification includes a leveling member (shaping device) 53 having protuberances 57 formed on a lower surface 55 thereof. The protuberances 57 are formed to correspond to the pitch P1 of arrangement of discharge openings 7a formed in the nozzle 17, and have a semicircular contour.

With this leveling member 53, as shown in FIG. 7, the barrier ribs WL′ have upper surfaces leveled and also pressed in by the protuberances 57 to define grooves 57A. The grooves 67A formed in this way promote adhesion of a faceplate placed in contact with the barrier ribs WL′ when assembling a PDP.

<Third Modification>

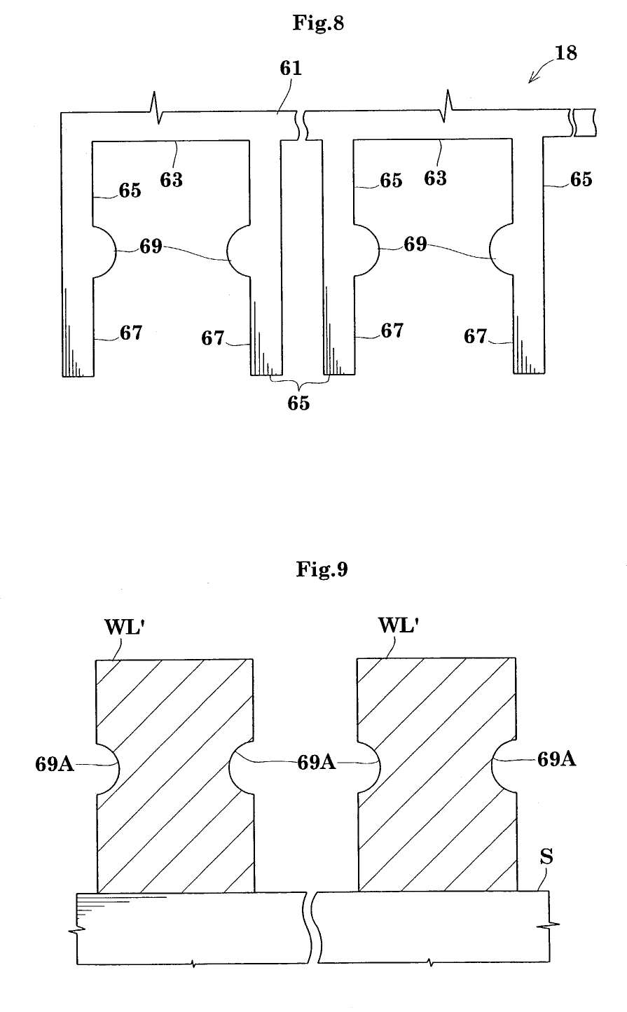

A third modification of the leveling mechanism 18 will be described with reference to FIGS. 8 and 9. FIG. 8 is a front view showing the third modification (seen from the right-hand side in FIG. 1). FIG. 9 is a view in vertical section of shaped barrier ribs in the third modification.

This modification is constructed to level all the surfaces, including side surfaces as well as upper surfaces, of the barrier ribs WL.

The modification includes a leveling member (shaping device) 61 having protuberances 69 formed on inner surfaces 67 of depending walls 65 extending downward from a lower surface 63. The depending walls 65 forming a pair serve to level side surfaces of one barrier rib WL, and are slightly less spaced from each other than the width of the barrier rib WL. The protuberances 69 formed on the inner surfaces 67 of depending walls 65 have a semicircular contour.

With this leveling member 61, as shown in FIG. 9, the barrier ribs WL′ have upper surfaces leveled and side surfaces pressed in by the protuberances 69 to define grooves 69A. The grooves 69A formed in this way promote adhesion of a fluorescent material applied, and increase the surface area of the fluorescent material. Thus, a highly reliable, bright PDP is obtained by using the back plate S having the barrier ribs WL′ formed as described above.

<Fourth Modification>

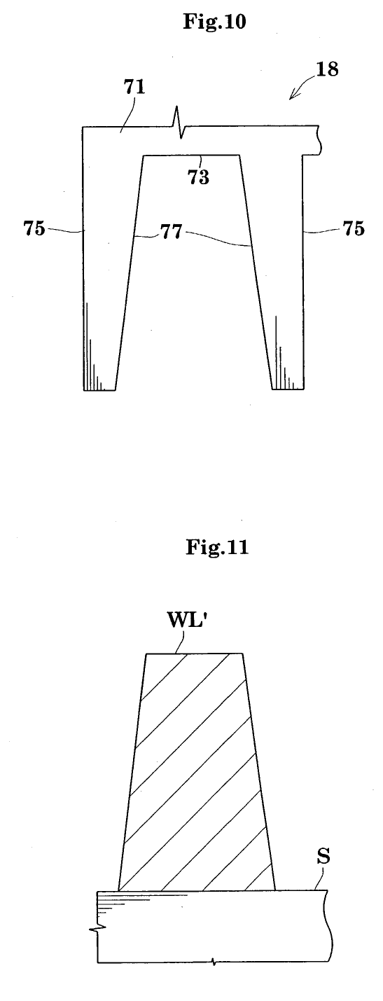

A fourth modification of the leveling mechanism 18 will be described with reference to FIGS. 10 and 11. FIG. 10 is a front view showing the fourth modification (seen from the right-hand side in FIG. 1). FIG. 11 is a view in vertical section of a shaped barrier rib in the fourth modification.

This modification is constructed to level all the surfaces, including side surfaces as well as upper surfaces, of the barrier ribs WL, and also to reshape their profile in vertical section.

The modification includes a leveling member (shaping device) 71 having depending walls 75 extending downward from a lower surface 73, the depending walls 75 having inclined inner surfaces 77. The inner surfaces 77 are inclined to converge upward. The depending walls 75 forming a pair serve to level side surfaces of one barrier rib WL, and are slightly less spaced from each other than the width of the barrier rib WL.

With this leveling member 71, as shown in FIG. 11, the rib material M_{W} delivered from the discharge openings 17a is reshaped in vertical section by the lower surface 73 and inner surfaces 77 into barrier ribs WL′ having leveled surfaces. Thus, the barrier ribs WL′ have a desired sectional profile regardless of the shape of discharge openings 17a, and improved surface planarity.

This invention is not limited to the above embodiment and modifications, but may be implemented in the following forms:

(1) The curing device using ultraviolet light may be replaced by a curing device for emitting infrared radiation to effect curing with heat.

(2) The support table 1 may be fixed, with the delivery unit 15 adapted movable.

(3) Instead of using the nozzle 17 having a plurality of discharge openings 17a to form all barrier ribs in one relative movement, a nozzle having a smaller number of discharge openings than a required number of barrier ribs may be used to form barrier ribs over the entire surface of back plate S in a plurality of relative movements.

The present invention may be embodied in other specific forms without departing from the spirit or essential attributes thereof and, accordingly, reference should be made to the appended claims, rather than to the foregoing specification, as indicating the scope of the invention.

What is claimed is:

1. A method of forming barrier ribs on a back plate for use in a flat panel display, said method comprising:
a step of delivering a rib material from a nozzle and leveling surfaces of said barrier ribs while moving said nozzle and said back plate relative to each other.

2. A method as defined in claim 1, wherein said surfaces of said barrier ribs are upper surfaces of said barrier ribs.

3. A method as defined in claim 1, wherein said rib material delivered from said nozzle is irradiated with light or heat.

4. A method as defined in claim 2, wherein said rib material delivered from said nozzle is irradiated with light or heat.

5. A method as defined in claim 3, wherein at least portions of said barrier ribs being leveled are irradiated with light or heat.

6. A method as defined in claim 4, wherein at least portions of said barrier ribs being leveled are irradiated with light or heat.

7. A method as defined in claim 1, wherein said barrier ribs are leveled by a leveling bar having a curved surface for contacting said barrier ribs.

8. A method as defined in claim 1, wherein said barrier ribs are leveled by a blade having planar surfaces for contacting said barrier ribs.

9. A method of forming barrier ribs on a back plate for use in a flat panel display, said method comprising:
a step of delivering a rib material from a nozzle and shaping a sectional profile of said barrier ribs while moving said nozzle and said back plate relative to each other.

10. A method as defined in claim 9, wherein at least an upper portion of said sectional profile of said barrier ribs is shaped.

11. A method as defined in claim 9, wherein said rib material delivered from said nozzle is irradiated with light or heat.

12. A method as defined in claim 10, wherein said rib material delivered from said nozzle is irradiated with light or heat.

13. An apparatus for forming barrier ribs on a back plate for use in a flat panel display, said apparatus comprising:
a nozzle for delivering a rib material;
a support table for supporting said back plate;
moving means for moving said nozzle and said support table relative to each other; and
leveling means for leveling surfaces of said barrier ribs on said back plate;
wherein said rib material is delivered from said nozzle and said barrier ribs are leveled by said leveling means while said nozzle and said back plate are moved relative to each other by said moving means.

14. An apparatus as defined in claim 13, wherein said leveling means is arranged to level upper surfaces of said barrier ribs.

15. An apparatus as defined in claim 13, further comprising curing means for curing said rib material delivered to said back plate.

16. An apparatus as defined in claim 14, further comprising curing means for curing said rib material delivered to said back plate.

17. An apparatus as defined in claim 15, wherein said curing means is arranged to cure a range including portions of said barrier ribs contacted by said leveling means.

18. An apparatus as defined in claim 16, wherein said curing means is arranged to cure a range including portions of said barrier ribs contacted by said leveling means.

19. An apparatus as defined in claim 13, wherein said leveling means includes a leveling bar having a curved surface for contacting said barrier ribs.

20. An apparatus as defined in claim 13, wherein said leveling means includes a blade having planar surfaces for contacting said barrier ribs.

21. An apparatus for forming barrier ribs on a back plate for use in a flat panel display, said apparatus comprising:
a nozzle for delivering a rib material;
a support table for supporting said back plate;
moving means for moving said nozzle and said support table relative to each other; and
shaping means for shaping a sectional profile of said barrier ribs on said back plate;
wherein said rib material is delivered from said nozzle and said barrier ribs are shaped by said shaping means while said nozzle and said back plate are moved relative to each other by said moving means.

22. An apparatus as defined in claim 21, wherein said shaping means is arranged to shape at least an upper portion of said sectional profile of said barrier ribs.

23. An apparatus as defined in claim 21, further comprising curing means for curing said rib material delivered from said nozzle.

24. An apparatus as defined in claim 22, further comprising curing means for curing said rib material delivered from said nozzle.

25. A back plate for a flat panel display comprising barrier ribs formed thereon by delivering a rib material from a nozzle and leveling surfaces of said barrier ribs while moving said nozzle and said back plate relative to each other.

26. A back plate as defined in claim 25, wherein said surfaces of said barrier ribs are upper surfaces of said barrier ribs.

27. A back plate as defined in claim 25, wherein said rib material delivered from said nozzle is irradiated with light or heat.

28. A back plate as defined in claim 26, wherein said rib material delivered from said nozzle is irradiated with light or heat.

29. A back plate as defined in claim 27, wherein at least portions of said barrier ribs being leveled are irradiated with light or heat.

30. A back plate as defined in claim 28, wherein at least portions of said barrier ribs being leveled are irradiated with light or heat.

31. A back plate as defined in claim 25, wherein said barrier ribs are leveled by a leveling bar having a curved surface for contacting said barrier ribs.

32. A back plate as defined in claim 25, wherein said barrier ribs are leveled by a blade having planar surfaces for contacting said barrier ribs.
